(19) United States
(12) Patent Application Publication
(10) Pub. No.: US 2020/0230948 A1
(43) Pub. Date: Jul. 23, 2020

(54) MULTILAYER ENDLESS BELT, INKJET IMAGE FORMING APPARATUS AND ELECTROPHOTOGRAPHIC IMAGE FORMING APPARATUS INCLUDING THE SAME, AND METHOD FOR PRODUCING MULTILAYER ENDLESS BELT

(71) Applicant: Konica Minolta, Inc., Tokyo (JP)

(72) Inventors: Junji Ujihara, Tokyo (JP); Tsuyoshi Shimoda, Tokyo (JP); Takayuki Suzuki, Niiza-shi (JP); Hirofumi Koga, Tokyo (JP)

(21) Appl. No.: 16/682,668

(22) Filed: Nov. 13, 2019

(30) Foreign Application Priority Data
Jan. 17, 2019 (JP) 2019-006345

(51) Int. Cl. B41J 2/005; G03G 15/16

(52) U.S. Cl. CPC B41J 2/0057; G03G 15/162

(57) ABSTRACT

Provided is a multilayer endless belt containing a base material layer having thereon an elastic layer in that order from an inner side of the multilayer endless belt, wherein in a width direction of the multilayer endless belt, an average thickness of both end regions of the base material layer is in the range of 120 to 150% with respect to an average thickness of a central region of the base material layer, and an average thickness of both end regions of the elastic layer is thinner than an average thickness of a central region of the elastic layer.

### CROSS-REFERENCE TO RELATED APPLICATION

The entire disclosure of Japanese Patent Application No. 2019-006345 filed on Jan. 17, 2019 with Japan Patent Office is incorporated herein by reference in its entirety.

### BACKGROUND

### 1. Technological Field

The present invention relates to a multilayer endless belt, an ink jet image forming apparatus and, an electrophotographic image forming apparatus including the same, and a method for producing the multilayer endless belt. More specifically, the present invention relates to a multilayer endless belt having little warpage and excellent durability.

### 2. Description of the Related Art

In recent years, images are often formed on various papers and paper sizes using an inkjet method and an electrophotographic method. In addition, not only normal smooth paper, a wide range of paper from the high smoothness such as coated paper to the one having rough surface properties such as embossed paper, Japanese paper and kraft paper is increasingly used. The followability to papers having different surface properties is important. When the followability is poor, uneven color density due to the uneven surface of the paper occurs and uneven color tone occurs depending on position of the paper.

In order to solve this problem, various multilayer endless belts in which a relatively flexible rubber elastic layer is laminated on a base material layer have been proposed as intermediate transfer belts. However, since such a rubber elastic layer has a large thermal shrinkage when molded on the base material layer, the warp of the intermediate transfer belt has been a problem. In particular, this problem becomes more prominent when the belt diameter is increased due to recent demands for higher speed and mass production. The end of the intermediate transfer belt warps to the outer peripheral surface side, causing problems such as damage to the intermediate transfer belt and meandering due to interference.

Further, due to the recent downsizing of multifunction devices due to space saving, the distance between members becomes narrower, the members tend to interfere with each other when the intermediate transfer unit is attached and detached, and the folding of both ends of the intermediate transfer belt during attachment and removal is also a problem.

In order to address the problem of warping, Patent Document 1 (JP-A 2013-195891) proposes that acrylonitrile butadiene rubber is used as a matrix polymer in the rubber elastic layer and chloroprene rubber is contained to suppress warping of the belt end. However, in the configuration described in this publication, it is necessary to increase the rubber layer in order to soften the rubber hardness to improve the followability to paper having rough surface properties such as embossed paper. When the thickness is increased, the warp of the belt end portion becomes large. This technology is not sufficient.

Patent Document 2 (JP-A 2013-109002) proposes to have silicone spherical fine particles on the surface of the rubber elastic layer to suppress the warping of the belt end. However, the toner cleaning property attached to the belt surface is not sufficient when durability is included, and the rubber hardness of the surface is high, and the followability to a paper having a rough surface property is not sufficient.

Patent Document 3 (JP-A 2012-91328) proposes a belt in which the film thickness at both ends is increased. However, the purpose is to reinforce the strength at both ends of the belt, and the belt surface including both ends is not flat, so the toner cleaning property is not sufficient.

### SUMMARY

The present invention has been made in view of the above-mentioned problems and situations. An object of the present invention is to provide a multilayer endless belt excellent in durability that has high image quality even on paper having a rough surface shape and does not warp even after long-term use. Another object of the present invention is to provide an inkjet image forming apparatus and an electrophotographic image forming apparatus including the multilayer endless belt, and a production method of the multilayer endless belt.

To achieve at least one of the abovementioned objects, according to an aspect of the present invention, the multilayer endless belt that reflects an aspect of the present invention is a multilayer endless belt comprising a base material layer having thereon an elastic layer in that order from an inner side of the multilayer endless belt, wherein in a width direction of the multilayer endless belt, an average thickness of both end regions of the base material layer is in the range of 120 to 150% with respect to an average thickness of a central region of the base material layer, and an average thickness of both end regions of the elastic layer is thinner than an average thickness of a central region of the elastic layer.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a conceptual cross-sectional view in the width direction illustrating an example of a multilayer endless belt of the present invention.

FIG. 2 is an embodiment of an apparatus for producing the multilayer endless belt of the present invention.

FIG. 3 is an example of a cross-sectional view of an electrophotographic image forming apparatus using the multilayer endless belt of the present invention as an intermediate transfer belt.

FIG. 4 is a side view illustrating the concept of an inkjet image forming apparatus using the multilayer endless belt of the present invention as an intermediate transfer belt.

### DETAILED DESCRIPTION OF THE EMBODIMENTS

Hereinafter, one or more embodiments of the present invention will be described. However, the scope of the invention is not limited to the disclosed embodiments.

The multilayer endless belt of the present invention is a multilayer endless belt comprising a base material layer having thereon an elastic layer in that order from an inner side of the multilayer endless belt, wherein in a width direction of the multilayer endless belt, an average thickness of both end regions of the base material layer is in the range of 120 to 150% with respect to an average thickness of a central region of the base material layer, and an average thickness of both end regions of the elastic layer is thinner than an average thickness of a central region of the elastic layer. This feature is a technical feature common to or corresponding to each of the following embodiments.

According to the present invention, it is possible to provide a multilayer endless belt excellent in durability that has high image quality even on paper having a rough surface shape and does not warp even after long-term use.

In addition, it is possible to provide an inkjet image forming apparatus and an electrophotographic image forming apparatus including the multilayer endless belt, and a production method of the multilayer endless belt.

The expression mechanism or action mechanism of the effect of the present invention is not clear, but it is presumed as follows.

In the intermediate transfer belt having an elastic layer laminated on the base material layer, since the elastic layer has a large thermal shrinkage during molding compared to the base material layer, both ends of the belt are greatly warped toward the surface side, and the amount of warpage increases as the outer diameter of the belt increases. In the present invention, the strength of the base material layer is increased with respect to external force by making the both end regions of the base material layer to have a thickness in a specific range of 120 to 150% with respect to the average thickness of the central region of the base material layer, and it becomes difficult to deform. In addition, by making the average thickness of the both end regions of the elastic layer thinner than the average thickness of the central region of the elastic layer, the contraction force of the both end regions of the elastic layer is reduced, and deformation becomes difficult. Thereby, it is assumed that the amount of warping is suppressed.

As an embodiment of the present invention, from the viewpoint of the effect of the present invention, an outer peripheral length is preferably 800 mm or more, an average thickness of the central region of the base material layer is preferably in the range of 100 to 130 μm, and an average thickness of the central region is preferably 300 μm or more. Further, a length in the width direction of the both end regions is preferably in the range of 8 to 17% from both ends with respect to the width of the multilayer endless belt from the viewpoint of realizing a multifunction device capable of suppressing warpage and saving space.

Further, in this invention, it is preferable from a viewpoint of suppressing warpage that the thickness of the base material layer and the elastic layer in the both end regions Relation 1 describe later. As an embodiment of the present invention, it is preferable that the average thickness of the base material layer and the elastic layer is the same in both end regions and the central region from the viewpoint of manifesting the effects of the present invention.

Further, the multilayer endless belt of the present invention is preferably used for an intermediate transfer belt for forming an inkjet image because of excellent durability. Further, in the present invention, the multilayer endless belt of the present invention is preferably used for an intermediate transfer belt for forming an electrophotographic image because of excellent durability. The multilayer endless belt of the present invention may be suitably provided in an inkjet image forming apparatus and an electrophotographic image forming apparatus.

As a method for producing a multilayer endless belt according to the present invention, a coating liquid containing a polyimide resin precursor or a polyamideimide resin precursor is applied using a nozzle that moves relative to an outer peripheral surface of a mold to form a coating film in the central region, then to form a coating film in both end regions so as to form the base material layer. As a method for producing a multilayer endless belt according to the present invention, a coating liquid containing an acrylonitrile rubber, a chloroprene rubber or a silicone rubber is applied using a nozzle that moves relative to a surface of the base material layer to form a coating film in the central region, then to form a coating film in the both end regions so as to form the elastic layer.

The present invention and the constitution elements thereof, as well as configurations and embodiments, will be detailed in the following. In the present description, when two figures are used to indicate a range of value before and after “to”, these figures are included in the range as a lowest limit value and an upper limit value.

<<Multilayer Endless Belt>>

The multilayer endless belt of the present invention is a multilayer endless belt comprising a base material layer having thereon an elastic layer in that order from an inner side of the multilayer endless belt, wherein in a width direction of the multilayer endless belt, an average thickness of both end regions of the base material layer is in the range of 120 to 150% with respect to an average thickness of a central region of the base material layer, and an average thickness of both end regions of the elastic layer is thinner than an average thickness of a central region of the elastic layer.

[Both End Regions and Central Region]

FIG. 1 is a conceptual cross-sectional view in the width direction illustrating an example of a multilayer endless belt of the present invention. In FIG. 1, 1a is a multilayer endless belt, 2a is a base material layer, 3a is an elastic layer, and 4a is a surface layer. The multilayer endless belt 1a of the present invention may be composed of only the base material layer 2a and the elastic layer 3a, but it may have a structure containing a layer such as the surface layer 4a as necessary. In the multilayer endless belt 1a of the present invention, the average thicknesses (b11 and b12) of the base layer 2a of the end region B1 and the end region B2 constituting the both end regions B with respect to the belt width W are respectively in the range of 120 to 150% of the average thickness (a1) of the central region A of the base material layer 2a. In addition, the average thickness (b21 and b22) of both end regions B of the elastic layer 3a is thinner than the average thickness (a2) of the central region of the elastic layer.

In the present invention, the central region refers to a region 30 mm left and right from the center (W/2) of the width of the multilayer endless belt in the width direction. The average thickness of the central region is determined by measuring the thickness of the region at a pitch of 5 mm and at four locations in the circumferential direction (in increments of 90°), and taking the arithmetic average value as the average thickness (number of film thickness measurements: 13×4=average value of 52 locations).

Moreover, the both end region relating to the present invention may be detected as follows using the profile of the measured thickness in the width direction.

Procedure 1: After fixing the base material layer applied on the mold, the thickness is measured at intervals of 1 mm from the end in the belt width direction, and the thickness from the end toward the center is measured.

Procedure 2: The point reaching the thickness of +5% with respect to the average thickness of the central region is searched for, and the region from the end to the point is defined as the end region. As for the thickness of both end regions, the arithmetic average value of the thicknesses measured at intervals of 5 mm from the end is defined as the thickness of both ends. This is performed for the end region B1 and the end region B2 constituting the both end regions B. Further, the thicknesses at four locations (in increments of 90°) are measured in the circumferential direction, and the arithmetic average values are used as the average thicknesses of the end region B1 and the end region B2, respectively. In the present invention, each of the end region B1 and the end region B2 constituting the both end regions B needs to satisfy the thickness requirements of the base material layer and the elastic layer according to the present invention.

In the present invention, by increasing the thickness of only the both end regions of the base material layer 2a as described above, the strength increases with respect to external force, and the amount of warpage may be suppressed by making it difficult to deform. When the average thickness of both end regions B of the base material layer 2a exceeds 150% with respect to the average thickness of the central region A at the center of the belt, warpage occurs in the base material layer 2a itself due to the thermal contraction between the both end region B and the central region A of the base material layer 2a. Therefore, the upper limit is 150%. The lower limit thickness is 120%, and when it is below the lower limit, the effect of suppressing warpage is insufficient due to insufficient strength of the base material layer 2a. Since the thermal shrinkage may be suppressed by reducing the thickness of the elastic layer 3a in both end regions, the amount of warpage may be suppressed.

The end region B1 and the end region B2 constituting the both end regions B are preferably regions respectively within a range of 8 to 17% from both ends with respect to the width of the multilayer endless belt. When it is 8% or more, it will withstand the heat shrinkage of the elastic layer and the amount of warping will not increase. Moreover, when it is within 17%, film shrinkage of the base material layer itself does not appear and the dimensional accuracy of the multilayer endless belt does not deteriorate. Further, the difference between the end region B1 and the end region B2 constituting the both end regions B is preferably within 2%, and more preferably the same length. In addition, it is preferable that the image transfer region C having the same thickness as the central portion A is used for image transfer during image transfer.

The thickness of the base material layer of the multilayer endless belt may be measured using MMS (manufactured by Fisher Instruments Co., Ltd.) after fixing the base material layer provided on the mold. Moreover, the elastic layer formed on the base material layer may be measured in the same manner, and the thickness may be calculated by subtracting the base material layer. The surface layer may be similarly measured.

Moreover, it is preferable that the thickness of edge region B1 and edge region B2 of the base material layer is the same. In the elastic layer, the end region B1 and the end region B2 preferably have the same thickness. In the present invention, it is preferable that the outer peripheral length is 800 mm or more, the average thickness of the central region of the base material layer is in the range of 100 to 130 μm, and the average thickness of the central region of the multilayer endless belt is 300 μm or more.

From the viewpoint of suppressing warpage, it is preferable that the thicknesses of the base material layer and the elastic layer in the both end regions satisfy the following relation 1.

(Average thickness of elastic layer in both end regions)/(average thickness of base material layer in both end regions)≤3.5. Relation 1:

Moreover, it is preferable from a viewpoint of making a cleaning characteristic favorable that the sum total of the average thickness of the said base material layer and the said elastic layer is the same in both end regions and central region. The total thickness being the same means that the sum of the average thicknesses of the base material layer and the elastic layer has a difference in average thickness of 5 μm or less in both end regions and the central region.

Further, although the thickness of the multilayer endless belt may be appropriately determined according to the purpose of use, but it is preferably 300 to 800 μm. The thinner the thickness is, the lower the voltage required for transfer is, so that discharge is suppressed and transfer efficiency is improved. Therefore, the thickness is preferably 800 μm or less. Further, when the thickness is 300 μm or more, the strength of the multilayer endless belt may be sufficiently maintained

### (Measurement of Amount of Warpage)

The amount of warpage may be measured as follows: by cutting the multilayer endless belt in the width direction and placing it on a flat table, separating 20 cm from the cut portion, and measuring the maximum value of the amount floating from the flat table with a caliper. The details of the configuration of the multilayer endless belt will be described below.

### <<Base Material Layer>>

The base material layer according to the present invention is formed with a base material layer forming composition containing a resin and a conductive material.

### [Resin]

Although various resins may be used for the base material layer forming composition, preferable resins are super-engineering plastics having strength and resistance such as polyimide (PI), polyamideimide (PAH, polyphenylene sulfide (PPS), and polyetheretherketone (PEEK).

Of these, polyimide, polyamide and polyamideimide are preferable. Among them, polyimide is more preferable. Polyimide is excellent in characteristics such as heat resistance, flexing resistance, flexibility, and dimensional stability, and it is suitably used for an intermediate transfer belt in an image forming apparatus. Polyimide is obtained, for example, by synthesizing a polyamic acid (polyimide precursor) from an acid anhydride and a diamine compound and imidizing the polyamic acid with heat or a catalyst.

The acid anhydride used for the synthesis of polyimide is not particularly limited. Examples thereof are aromatic tetracarboxylic dianhydrides such as: biphenyltetracarboxylic dianhydride, terphenyltetracarboxylic dianhydride, benzophenonetetracarboxylic dianhydride, pyromellitic anhydride, oxydiphthalic dianhydride, diphenylsulfone tetracarboxylic dianhydride, hexafluoroisopropylidene diphthalic acid dianhydride, and cyclobutanetetracarboxylic acid dianhydride.

The diamine compound used for the synthesis of polyimide is not particularly limited. Examples thereof are aromatic diamines such as: p-phenylenediamine, m-phenylenediamine, 2,4-diaminotoluene, 4,4′-diaminodiphenylmethane, 4,4′-diaminodiphenyl ether, 3,4′-diaminodiphenyl ether, 3,3′-dimethyl-4,4′-diaminobiphenyl, 2,2′-bis (trifluoromethyl)-4,4′-diaminobiphenyl, 3,7-diamino-dimethyldibenzothiophene-5,5′-dioxide, 4,4′-diaminobenzophenone, 4,4′-bis(4-aminophenyl) sulfide, 4,4′-diaminobenzanilide, and 1,4-bis(4-aminophenoxy)benzene.

Further, as commercially available products, a polyimide varnish mainly composed of a polyimide precursor (for example, U-varnish S: manufactured by Ube Industries) or a polyamide imide varnish mainly composed of a polyamideimide precursor (for example, HR-16NN: Toyobo Co., Ltd.) may also be used.

### (Conductive Agent)

As the conductive agent dispersed in the base material layer of the present invention, well-known electron conductive substances and ion conductive substances may be used. Examples of the electron conductive substance are: carbon black; carbon for rubber such as SAF (super wear resistance), ISAF (quasi super abrasion resistance), HAF (high abrasion resistance), FEF (good extrusion property), GPF (versatility), SRF (medium reinforcement), FT (fine particle pyrolytic property), MT (medium grain thermally decomposable); carbon for color (ink) subjected to oxidation treatment, pyrolytic carbon, natural graphite, synthetic graphite; antimony-doped tin oxide, titanium oxide, zinc oxide; metals and metal oxides made of nickel, copper, silver, and germanium; and conductive polymers such as polyaniline, polypyrrole, and polyacetylene.

Examples of the ion conductive substances are: inorganic ionic conductive substances such as sodium perchlorate, lithium perchlorate, calcium perchlorate, and lithium chloride; organic ionic conductive substances such as perchlorate, sulfate, ethosulfate, methylsulfate, phosphate, fluoroborate, and acetate of quaternary ammonium; and charge transfer complexes. Specific examples of the organic ionic conductive substance are: tridecyl methyl dihydroxyethyl ammonium perchlorate, lauryl trimethyl ammonium perchlorate, modified aliphatic-dimethylethylammonium ethosulfate, N,N-bis(2-hydroxyethyl)-N-(3′-dodecyloxy-2′−)methyl ammonium ethosulfate, 3-lauramidopropyl-tolymethyl ammonium methyl sulfate, stearamidopropyl dimethyl-β-hydroxyethyl-ammonium dihydrogen phosphate, tetrabutyl ammonium borate, stearyl ammonium acetate, and lauryl ammonium acetate. These conductive agents may be used singly or in combination of two or more.

Among the conductive agents, carbon black is preferably used. As the carbon black, for example, gas black, acetylene black, oil furnace black, thermal black, channel black, and Ketjen black may be mentioned. Ketjen black, acetylene black and oil furnace black may be cited as effective ones for obtaining a desired conductivity with a smaller amount of mixing. It should be noted that Ketjen black is carbon black of a contactive furnace system.

By appropriately using the above-mentioned conductive agent, conductivity may be imparted to the base material layer, and the volume resistivity of the multilayer endless intermediate belt may be adjusted in the range of 1.0×10⁵ to 9.0×10⁹ Ω·cm at 100 V. The content of the conductive agent is from 6 to 20 mass %, preferably from 8 to 12 mass %, based on 100 mass % of the base material layer forming composition when the above-mentioned electron conductive substance is used as the conductive agent. When the ion conductive substance is used as the conductive agent, it is preferably used in an amount of 10 to 50 mass %, particularly 20 to 40 mass %, based on 100 mass % of the base material layer forming composition.

### <<Elastic Layer>>

The elastic layer is a layer having desired conductivity and elasticity formed on the outer peripheral surface of the base material. The elastic layer is made of a rubber material. The thickness of the elastic layer is, for example, 50 to 400 μm. Examples of the rubber material include resins having rubber elasticity such as urethane rubber, chloroprene rubber, and nitrile rubber. The rubber material preferably contains chloroprene rubber or nitrile butadiene rubber from the viewpoint of controlling the electric resistance of the multilayer endless belt.

### <<Surface Layer>>

When needed, the surface layer may be formed on the outer peripheral surface of the elastic layer. Known resins and additives are used for the surface layer. Moreover, it is possible to use the surface layer after curing with a conventionally well-known method. The surface layer is preferably obtained by irradiating the coating film of the surface layer forming coating solution with active energy rays and curing. The durability of the multilayer endless belt will be improved. Here, the surface layer forming coating solution contains metal oxide fine particles (A); and an active energy ray-curable composition containing a (meth)acrylate monomer (B) having a refractive index nD in the range of 1.6 to 1.8 and a polyfunctional (meth)acrylate monomer (C) other than the (meth)acrylate monomer (B). Thereby, durability of a multilayer endless belt may be improved.

### <Method of Producing Multilayer Endless Belt>

Next, a method of producing a multilayer endless belt will be described. A method of producing a multilayer endless belt of the present invention preferably contains the step of forming a base material layer by firstly forming a coating film of a central region using a nozzle that moves a coating liquid containing a polyimide resin precursor or a polyamideimide resin precursor relative to an outer peripheral surface, thereafter, forming a coating film of end regions.

A method of producing a multilayer endless belt of the present invention preferably contains the step of forming an elastic layer by firstly forming a coating film of a central region using a nozzle that moves a coating liquid containing an acrylonitrile rubber, a chloroprene rubber or a silicone rubber, thereafter, forming a coating film of end regions. Thus, the multilayer endless belt having the both end regions according to the present invention may be efficiently produced by forming the base material layer and the elastic layer.

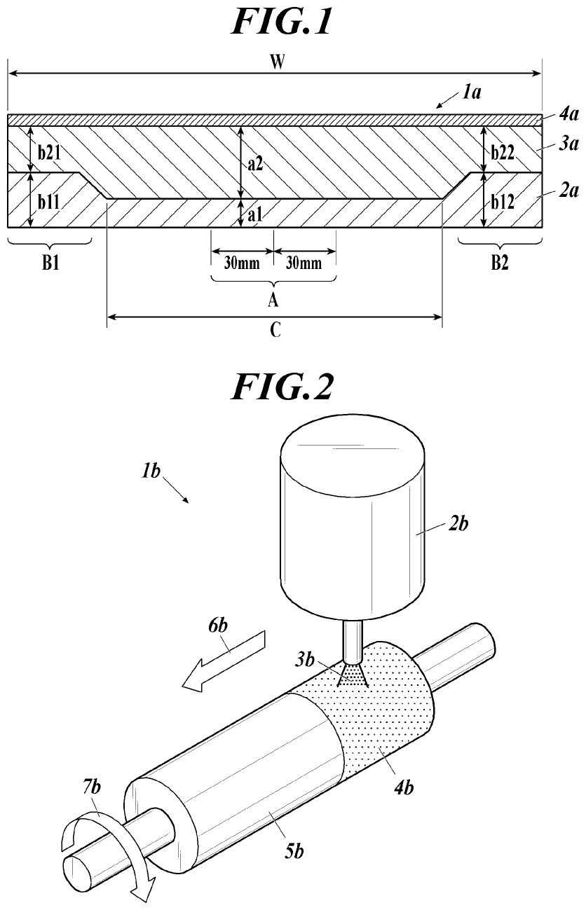

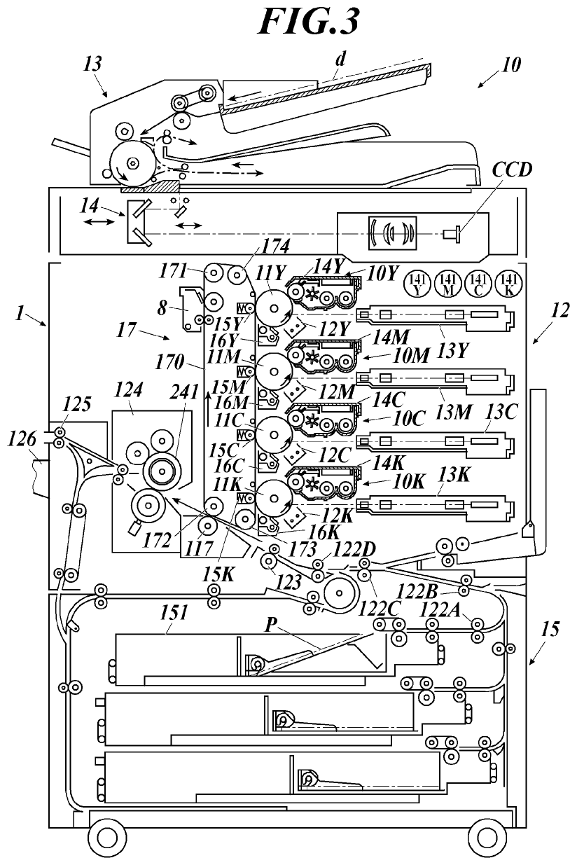

FIG. 2 is an embodiment of an apparatus for producing the multilayer endless belt of the present invention. As indicated in FIG. 2, the coating apparatus 1b includes a coating unit 2b having a nozzle and a metal cylinder 5b. The coating unit 2b mists the coating liquid having a desired composition and sprays the mist-like coating liquid 3b on the metal cylinder 5b to form the coating film 4b on the metal cylinder 5b. The metal cylinder 5b is rotated at a desired speed in the direction of the arrow 7b, and further a uniform coating film is formed while casting the coating liquid from the nozzle while moving the coating unit 2b in the direction of the arrow 6b.

According to a preferred embodiment, the base material layer may be produced using a coating liquid containing a flame retardant resin component, that is, a coating liquid containing a polyimide resin precursor or a polyamideimide resin precursor. While slowly rotating a cylindrical mold, for example, a cylindrical metal mold (mold drum: metal cylinder 5b), a coating liquid containing a flame-retardant resin component (for example, a coating liquid containing a polyimide resin precursor or a polyimide-imide resin precursor) is supplied with a liquid supply device (not indicated) such as a nozzle or a dispenser. A coating film is formed by coating and casting so that the thickness after the heat (firing) treatment becomes the thickness of the central region so as to be uniform over the entire outer surface of the metal cylinder 5b.

The number of rotations at this time is not particularly limited and may be set as appropriate according to the size of the metal cylinder 5b, but it is preferably about 30 to 80 rpm. While rotating with gradually raising the temperature, the solvent in the coating film is evaporated at a temperature of about 80 to 150° C. for about 30 to 90 minutes. In this process, it is preferable to efficiently circulate and remove atmospheric vapor (such as a volatilized solvent). Next, a coating film of the same coating solution as that of the central region is formed only in the both end regions so that the thickness after the heating (firing) treatment becomes the thickness of the both end regions. The thickness may be controlled by controlling the supply amount of the coating liquid.

When the self-supporting film is formed, the metal cylinder 5b is transferred to a heating furnace (firing furnace) capable of high-temperature treatment, and the temperature is raised stepwise. Finally, heat treatment (baking) is performed at a high temperature of about 250 to 450° C. for 10 to 90 minutes, and the polyimide resin precursor or polyamideimide resin precursor is fully imidized or polyamideimidized to form both end regions. The base material layer having the both end regions is produced. After producing the base material layer by imidization or polyamideimidation, the base material layer is sufficiently cooled, and then an elastic layer is laminated on the base material layer.

The elastic layer may be formed on the base material layer by injection molding or extrusion molding. However, here, a method of coating and forming the elastic layer on a base material layer using a thermosetting liquid elastomer material will be described.

For example, a coating liquid containing a liquid thermosetting elastomer material is coated and casted (forming a coating film) on the base material layer formed on the outer surface of the metal cylinder 5b by a liquid supply device (not indicated) such as a nozzle or a dispenser while slowly rotating a cylindrical metal mold (mold drum: metal cylinder 5b) as in the case of the base material layer. The number of rotations at this time is not particularly limited and may be set as appropriate according to the size of the metal cylinder 5b, but it is preferably about 30 to 80 rpm. However, at this time, it is preferable to firstly form a coating film in the central region and then form a coating film in the both end regions to form the elastic layer. In this way, the thicknesses of the both end regions and the central region may be controlled. The thickness may be controlled by controlling the supply amount of the coating liquid.

Then, the elastomer material is cured by heat treatment at a predetermined temperature and a predetermined time while rotating the metal cylinder 25b to form an elastic layer. As the elastomer material, an acrylonitrile rubber, a chloroprene rubber or a silicone rubber is preferable, and a coating solution containing these is preferably used.

Specific temperature conditions are not particularly limited, and may be appropriately selected depending on the type of coating solution. As a guide, it is about 35 to 70° C., and the time is about 10 to 90 minutes. When the self-supporting film is formed, the metal cylinder 5b is transferred to a heating furnace capable of high-temperature processing. The temperature is raised stepwise and finally heat-treated (vulcanized) at about 130 to 180° C. for 10 to 90 minutes. After producing the elastic layer, it is sufficiently cooled, and then a surface layer may be laminated on the elastic layer as necessary.

### <Application>

The multilayer endless belt of the present invention is suitably used for an intermediate transfer belt of an image forming apparatus such as an electrophotographic copying machine, a printer, or a facsimile. In particular, it is preferably used for an electrophotographic image forming apparatus and an inkjet image forming apparatus.

### [Electrophotographic Image Forming Apparatus]

FIG. 3 is an example of a cross-sectional view of an electrophotographic image forming apparatus using the multilayer endless belt of the present invention as an intermediate transfer belt. This electrophotographic image forming apparatus 10 is called a tandem type full-color copying machine, and it includes an automatic document feeder 13, a document image reading device 14, a plurality of exposure units 13Y, 13M, 13C, and 13K, and a plurality of image forming section 10Y, 10M, 10C, and 10K, an intermediate transfer member unit 17, a paper feeding unit 15, and a fixing unit 124.

An automatic document feeder 13 and a document image reading device 14 are arranged on the upper portion of the main body 12 of the electrophotographic image forming apparatus. The image of the document d conveyed by the automatic document feeder 13 is reflected and imaged by the optical system of the document image reader 14 and read by the line image sensor CCD.

The analog signal obtained by photoelectrically converting the original image read by the line image sensor CCD is subjected to analog processing, A/D conversion, shading correction, and image compression processing in an image processing unit (not indicated). Thereafter, it is sent to the exposure units 13Y, 13M, 13C, 13K as digital image data for each color. The exposure units 13Y, 13M, 13C, and 13K form latent images of the image data of the respective colors on the corresponding drum-shaped photoreceptors 11Y, 11M, 11C, and 11K as the corresponding first image carriers.

The image forming sections 10Y, 10M, 10C, and 10K are arranged in tandem in the vertical direction. An intermediate transfer belt 170 of the present invention which is a semiconductive and seamless belt-like second image carrier is arranged in the condition in which the intermediate transfer belt conveying rollers 171, 172, 173, and 174 are wound around the photoreceptors 11Y, 11M, 11C, and 11K on the left side of the drawing in a state where the rollers are rotatably supported.

The intermediate transfer belt 170 of the present invention is driven in the arrow direction via a roller 171 that is rotationally driven by a driving device (not indicated).

An image forming section 10Y that forms a yellow image includes a charging unit 12Y, an exposure unit 13Y, a developing unit 14Y, a primary transfer roller 15Y as a primary transfer unit, and a cleaning unit 16Y disposed around the photoreceptor 11Y.

An image forming section 10M that forms a magenta image includes a photoreceptor 11M, a charging unit 12M, an exposure unit 13M, a developing unit 14M, a primary transfer roller 15M as a primary transfer unit, and a cleaning unit 16M.

An image forming section 10C that forms a cyan image includes a photoreceptor 11C, a charging unit 12C, an exposure unit 13C, a developing unit 14C, a primary transfer roller 15C as a primary transfer unit, and a cleaning unit 16C.

An image forming section 10K that forms a black image includes a photoreceptor 11K, a charging unit 12K, an exposure unit 13K, a developing unit 14K, a primary transfer roller 15K as a primary transfer unit, and a cleaning unit 16K.

The toner replenishing units 141Y, 141M, 141C, and 141K replenish new toner to the developing units 14Y, 14M, 14C, and 14K, respectively.

Here, the primary transfer rollers 15Y, 15M, 15C, and 15K are selectively operated according to the type of image by a control unit (not indicated). The intermediate transfer belt 170 is pressed against the corresponding photoreceptors 11Y, 11M, 11C, and 11K, and the image on the photoreceptor is transferred.

In this way, each color image formed on the photoreceptors 11Y, 11M, 11C, and 11K by the image forming sections 10Y, 10M, 10C, and 10K is sequentially transferred onto the rotating intermediate transfer belt 170 to form a combined color image by the primary transfer rollers 15Y, 15M, 15C, and 15K. That is, the intermediate transfer belt is primarily transferred the toner image carried on the surface of the photosensitive member to the surface, and holds the transferred toner image.

Further, the transfer material P as a recording medium accommodated in the paper feed cassette 151 is fed by the paper feeding unit 15. Then, it is conveyed to a secondary transfer roller 117 as a secondary transfer unit thorough a plurality of intermediate rollers 122A, 122B, 122C, 122D and a registration roller 123. Thus, the combined toner image on the intermediate transfer member is transferred onto the transfer material P by the secondary transfer roller 117. That is, the toner image held on the intermediate transfer member is secondarily transferred to the surface of the transfer object. Here, the secondary transfer unit 6 presses the transfer material P against the intermediate transfer belt 170 only when the transfer material P passes through the secondary transfer unit 6 and performs the secondary transfer.

The transfer material P onto which the color image has been transferred is subjected to fixing processing by the fixing device 124, sandwiched between the paper discharge rollers 125, and placed on a paper discharge tray 126 outside the apparatus. On the other hand, after the color image is transferred to the transfer material P by the secondary transfer roller 117, the residual toner is removed by the cleaning unit 8 in the intermediate transfer belt 170 from which the transfer material P is separated by curvature. Here, the intermediate transfer member may be replaced with a rotating drum-like member as described above.

Next, the configuration of the primary transfer rollers 15Y, 15M, 15C, and 15K as the primary transfer unit that contacts the intermediate transfer belt 170 and the secondary transfer roller 117 will be described.

The primary transfer rollers 15Y, 15M, 15C, and 15K are formed by coating a semiconductive elastic rubber on the peripheral surface of a conductive core metal such as stainless steel having an outer diameter of 8 mm, for example. Conductive materials such as carbon are dispersed or ionic conductive materials are contained in polyurethane rubber, EPDM, silicone and other rubber materials on the peripheral surface of the conductive core metal to make the semiconductive elastic rubber in a solid or foamed sponge form with a volume resistance of about 1×10⁵ to 1×10⁹ Ω·cm, a thickness of 5 mm, and a rubber elastic modulus of about 20 to 70° (Asker elastic modulus C).

The secondary transfer roller 117 is formed by coating a semiconductive elastic rubber on the peripheral surface of a conductive core metal such as stainless steel having an outer diameter of 8 mm.

### (Transfer Material)

The transfer material used in the present invention is a support for holding a toner image, and is usually called an image support, a transfer material, or transfer paper. Preferable transfer materials include plain paper from thin paper to thick paper, coated printing paper such as art paper and coated paper, commercially available Japanese paper and postcard paper, uneven paper, plastic film for OHP, and cloth. However, it is not limited to these.

### [Inkjet Image Forming Apparatus]

The multilayer endless belt of the present invention may be preferably applied to an intermediate transfer belt in an inkjet image forming apparatus. Hereinafter, an inkjet image forming apparatus using an actinic ray curable inkjet ink that undergoes a sol-gel phase transition (hereinafter also simply referred to as “gel ink”) will be described as an example.

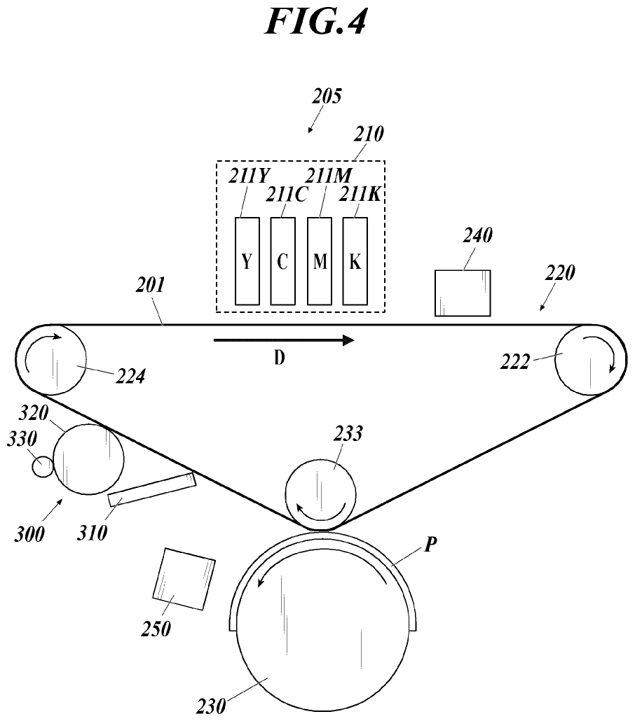

FIG. 4 is a side view illustrating the concept of an inkjet image forming apparatus using the multilayer endless belt of the present invention as an intermediate transfer belt. The image forming apparatus 205 includes an ink discharge section 210, an intermediate transfer unit 220, a paper transport unit 230, a first light irradiation unit 240, a second light irradiation unit 250, a cleaning unit 300, and a control section (not indicated). The control section (not indicated) includes a CPU (Central Processing Unit), a ROM (Read Only Memory), and a RAM (Random Access Memory). The CPU reads a program corresponding to the processing content from the ROM and develops it in the RAM, and centrally controls the operation of each block of the image forming apparatus 5 in cooperation with the developed program.

As indicated in FIG. 4, the ink discharge section 210 includes inkjet heads 211Y, 211C, 211M, and 211K, and inks of each color of Y (yellow), M (magenta), C (cyan), and K (black) are used. An image based on ink is formed by discharging to the intermediate transfer unit 220. Note that since the inkjet heads 211Y, 211C, 211M, and 211K have the same configuration, in the following description, Y, M, C, and K are omitted for the sake of convenience and referred to as “inkjet head 211”.

In the present invention, the ink ejected from each inkjet head 211 is preferably an ultraviolet curable ink containing, as a liquid component, a photopolymerizable compound that is polymerized and crosslinked by being irradiated with ultraviolet rays.

The intermediate transfer unit 220 includes the intermediate transfer belt 201 of the present invention that constitutes the transfer unit, and three support rollers 222, 223, and 224. The intermediate transfer belt 201 is formed of a multilayer endless belt, and is stretched around the three support rollers 222, 223, and 224 in an inverted triangle shape.

Of the three support rollers 222, 223, and 224, at least one roller is a drive roller and is driven under the control of the control unit. As a result, the intermediate transfer belt 201 rotates in the direction D (clockwise direction in FIG. 4).

The portions of the intermediate transfer belt 201 that are stretched around the support rollers 222 and 224 that are positioned at the left and right apex portions of an inverted triangle form a landing surface for ink ejected from the inkjet head 211. A support roller 223 located at the lower apex portion of the inverted triangular shape of the intermediate transfer belt 201 is a pressure roller that presses the intermediate transfer belt 201 toward the paper transport unit 230 with a predetermined nip pressure.

The paper transport unit 230 is configured by a metal drum, and forms a transfer nip by being pressed by the support roller 223. The paper transport unit 230 has a claw (not indicated) that fixes the leading edge of the paper P under the control of the control unit. The sheet conveyance unit 230 fixes the leading end of the sheet P to the claw and rotates counterclockwise in FIG. 4 to convey the sheet P as an example of the recording medium to the transfer nip.

The first light irradiation unit 240 faces the ink landing surface of the intermediate transfer belt 201 on the downstream side of the ink discharge section 210. The first light irradiation unit 240 irradiates the image formed on the intermediate transfer belt 201 with light, and pre-cures the image.

The second light irradiation unit 250 faces a portion of the paper transport unit 230 on the downstream side of the transfer nip, and irradiates the image on the paper P with light to fully cure the image.

The image formed on the surface of the intermediate transfer belt 201 by the inkjet head 211 is pre-cured by the first light irradiation unit 240 when the intermediate transfer belt 201 rotates, and the paper is conveyed to a transfer nip between the support roller 223 and the paper conveyance unit 230. Then, the image conveyed to the transfer nip is transferred to the sheet P conveyed by the sheet conveying unit 230. The image transferred to the paper P is fully cured by the second light irradiation unit 250.

The cleaning unit 300 is located downstream of the transfer nip, and includes a first cleaning member 310, a second cleaning member 320, a third cleaning member 330, and a fourth cleaning member 340 (not indicated).

The cleaning unit 300 removes a transfer residual image that is an image formed on the intermediate transfer belt 201 under the control of the control unit. The “transfer residual image” here refers to a transfer image that is not transferred onto the paper P but remains on the intermediate transfer belt 201.

The first cleaning member 310 is configured to be movable to a contact position that contacts the intermediate transfer belt 201.

The second cleaning member 320 is a cleaning roller such as a web roller or a sponge roller, and contacts the downstream portion of the first cleaning member 310 in the intermediate transfer belt 201.

The third cleaning member 330 is a cleaning roller that contacts the second cleaning member 320 on the side opposite to the intermediate transfer belt 201 with respect to the second cleaning member 320.

The inkjet head used in the image forming method may be an on-demand system or a continuous system. Specific examples of a discharge method include an electro-mechanical conversion method (e.g., single cavity type, double cavity type, bender type, piston type, shear mode type, and shared wall type), an electro-thermal conversion type (e.g., thermal ink jet type, bubble jet (registered trademark) type), an electrostatic attraction method (e.g., electric field control type and slit jet type), a discharge method (e.g., spark jet type). Any discharge method may be used. As a printing method, a serial head method or a line head method may be used without limitation.

As the ink jet head, an ink jet head having a configuration described in the following publications may be appropriately selected and applied. Examples of the publication are JP-A 2012-140017, JP-A 2013-010227, JP-A 2014-058171, JP-A 2014-097644, JP-A 2015-142979, and JP-A 2015-142980, JP-A 2016-002675, JP-A 2016-002682, JP-A 2016-107401, JP-A 2017-109476, and JP-A 2017-177626.

Further, examples of the ultraviolet irradiation means having a wavelength range of 360 to 410 nm in the first light irradiation unit 240 and the second light irradiation unit 250 include fluorescent tubes (for example, low-pressure mercury lamps, germicidal lamps, etc.), cold-cathode tubes, ultraviolet lasers, low-pressure, medium-pressure, high-pressure mercury lamps, metal halide lamps and LEDs having an operating pressure of several hundred Pa to 1 MPa. From the viewpoint of curability, an ultraviolet irradiation means for irradiating ultraviolet rays having an illuminance of 100 mW/cm² or more, specifically, a high-pressure mercury lamp, a metal halide lamp, or an LED is preferable. Specifically, a water-cooled LED (manufactured by Phoseon Technology Co., Ltd.) (wavelength: 395 nm) may be used.

### EXAMPLES

Hereinafter, the present invention will be specifically described by way of examples, but the present invention is not limited thereto. In addition, although the term “part” or ‘%’ is used in an Example, unless otherwise indicated, it represents “mass part” or “mass %”.

### <Preparation of Multilayer Endless Belt>

### [Preparation of Multilayer Endless Belt 1]

### <Formation of Base Material Layer>

To polyimide varnish (U-Varnish S manufactured by Ube Industries, Ltd.) with a solid content of 15 mass %, mainly composed of a polyimide resin precursor was added 100 ppm of leveling agent (KF-96 manufactured by Shin-Etsu Chemical Co., Ltd.) to the total weight of the polyimide varnish. The coating liquid for forming base material layer was prepared by mixing using a mixer.

Next, a cylindrical stainless steel mold having a circumferential length of 2500 mm and a width of 800 mm formed with a release agent is rotated at 100 rpm around the cylindrical axis, and while the dispenser nozzle is moved in the cylindrical axis direction, a wet film was formed so as to have a width of 560 mm and a thickness after firing of 100 μm. Next, while rotating both ends at 100 rpm around the cylindrical axis, the dispenser nozzle is moved in the cylindrical axis direction so that the coating width is 70 mm and the thickness after baking is 150 μm. Wet films were formed at both ends to form a wet film having a total width of 700 mm.

Subsequently, the solvent was volatilized to prevent the base material layer from flowing down by heating (baking) at 100° C. for 2 hours using a far-infrared dryer while rotating at 100 rpm around the cylindrical axis. Finally, the mold was introduced into a heating furnace and heated (baked) for 90 minutes in a state where the temperature was raised stepwise and maintained at 380° C. It was cooled sufficiently, and a polyimide base material layer having a thickness of the central region of 100 μm, a thickness of both end regions of 150 μm, the total width of 700 mm, and having both end regions B composed of B1 and B2 each having a width of 10% from both ends was obtained. At this stage, the thickness of the both end regions and the central region and the length from the ends of both end regions were measured using the MMS manufactured by Fisher Instruments Co., Ltd. It was confirmed that the thicknesses of the central region and both end regions were formed as shown in the table.

### <Formation of Elastic Layer>

The following components were dissolved in toluene so that the solid content concentration was 20 mass % in the following amount, and then a coating solution for forming an elastic layer was prepared.

### (Coating Solution for Forming Elastic Layer)

| | | |
|---|---|---|
| Matrix polymer: Acrylonitrile butadiene rubber | 100 | mass parts |
| DN003 (manufactured by ZEON Corporation): | | |
| Organic flame retardant: Trimethyl phosphate TPM | 30 | mass parts |
| (manufactured by Daihachi Chemical Industry Co., | | |
| Ltd.): | | |
| Resin crosslinking agent: Phenol novolac epoxy resin | 10 | mass parts |
| N-770 (manufactured by DIC Co., Ltd.): | | |
| Conductive agent: Tetrabutylammonium perchlorate | 1 | mass part |
| QAP-01 (Nippon Carlit Co., Ltd.): | | |

Next, using the polyimide base material layer formed on the outer peripheral surface of the mold, it was rotated at 200 rpm around the cylindrical axis. At the same time, while moving the dispenser nozzle in the cylindrical axis direction, a wet film was laminated between the end region B1 and the end region B2 so that the width was 560 mm and the thickness after firing was 300 μm. Subsequently, the dispenser nozzle was moved in the direction of the cylindrical axis so that the coating width was 70 mm and the thickness after baking was 250 μm while rotating at 200 rpm around the cylindrical axis, and wet films were formed at both ends to obtain a wet film with a total width of 700 mm. Subsequently, the solvent was volatilized by heating at 100° C. for 1 hour using a far-infrared dryer while rotating at 200 rpm around the cylindrical axis, so that the elastic layer did not flow down.

Finally, the mold was introduced into a heating furnace and heated (vulcanized) for 60 minutes in a state where the temperature was raised stepwise and maintained at 180° C. Then, it was sufficiently cooled, and the combined film thickness of the base material layer and the elastic layer was 400 μm at the central region and 400 μm at both end regions, and a laminated belt having a uniform thickness in the width direction was obtained.

### <Formation of Surface Layer>

The following components were dissolved and dispersed in propylene glycol monomethyl ether acetate (PMA) in the following amounts so that the solid content concentration was 10 mass %. Next, a coating solution for forming a surface layer was prepared by further adding 1 mass % of a surface tension adjusting agent (Silface SAG008: manufactured by Nissin Chemical Industry Co., Ltd.) to the total weight of the dispersion in which the following components were dispersed.

### (Coating Solution for Forming Surface Layer)

| | | |
|---|---|---|
| Pentaerythritol triacrylate: | 50 | mass parts |
| Polyurethane acrylate: | 50 | mass parts |
| Polymerization initiator: | 5 | mass parts |

As the radically polymerizable compound, pentaerythritol acrylate (M-305: manufactured by Toagosei Co., Ltd.) and polyurethane acrylate (UV-3520TL: manufactured by Nippon Synthetic Chemical Industry Co., Ltd.) were used. As the polymerization initiator, 1-hydroxy-cyclohexyl phenyl ketone (IRGACURE184: manufactured by BASF Japan) was used. Next, while rotating the laminated belt on which the elastic layer had been formed at 20 rpm, the outer circumferential surface of the laminated belt was spray-coated under the following spray coating conditions using a thin film spray coating device (manufactured by YD Mechatro Solutions Inc.) to form a wet film.

Next, the laminated belt on which the wet film was formed was heated at 60° C. for 30 minutes using a far-infrared dryer while rotating at 20 rpm around the cylindrical axis, thereby volatilizing the solvent. Next, while the laminated belt was rotated, ultraviolet rays were irradiated under the following irradiation conditions to perform curing by radical polymerization reaction. Thereby, a surface layer having a thickness of 2 μm was formed.

### (Spray Conditions)

| Nozzle scan speed: | 1 to 10 | mm/sec |
|---|---|---|
| Distance from the nozzle to the belt surface on | 100 to 150 | mm |
| which the elastic layer is formed: | | |
| Nozzle number: | 1 | |
| Liquid feeding flow rate: | 1 to 5 | ml/min |
| Air flow rate: | 2 to 6 | L/min |

### (Irradiation Conditions)

| Light source: | High-pressure mercury lamp (H04-L41: | |
|---|---|---|
| | manufactured by Eye Graphics Co., Ltd.) | |
| Distance from irradiation port | 100 | mm |
| to laminated belt: | | |
| Light intensity: | 1 | J/cm² |
| Irradiation time: | 240 | seconds |

Through the above steps, a multilayer endless belt 1 having a thickness of 402 μm, in which a base material layer, an elastic layer, and a surface layer were sequentially stacked, was produced.

### [Preparation of Multilayer Endless Belts 2 to 8]

### <Formation of Base Material Layer>

In the formation of the base material layer of the multilayer endless belt 1, by using the coating liquid for forming the base material layer with different types of resin, and by changing the ratio (%) of the both end regions B with respect to the total width, and by changing the thickness of the central region A and the both end regions B as described in Table I, base material layers for multilayer endless belts 2 to 8 were prepared. The thickness was determined by changing the supply amount of the coating liquid for forming the base material layer. For the preparation of the multilayer endless belts 4 and 5, a coating solution for forming a base material layer using a polyamideimide varnish (HR-16NN: manufactured by Toyobo Co., Ltd.) instead of the polyimide varnish (U-Varnish S manufactured by Ube Industries) was used. In Table I, the following abbreviations were used.

PI: Polyimide

PAI: Polyamideimide

### <Formation of Elastic Layer>

Using the coating liquid for forming an elastic layer in which the rubber material is changed as described in Table I on each of the base layers for the multilayer endless belts 2 to 8 produced as described above, the elastic layers of the multilayer endless belts 2 to 8 were formed by changing the ratio (%) and the thicknesses of the central region A and the both end regions B as indicated in Table I. The thickness was changed by changing the supply amount of the coating liquid for forming the elastic layer. In addition, each of the multilayer endless belts was formed so that the sum of the base material layer after baking and the elastic layer might become the same in the width direction.

The rubber materials indicated in Table I were as follows. They were indicated with abbreviation.

NBR: Acrylonitrile butadiene rubber (model number DN003, manufactured by Zeon Corporation)

SR: Silicone rubber (Model No. XE15-B73545 A agent/B agent, manufactured by Momentive Performance Material Japan LLC)

CR: Chloroprene rubber (model number DCR-75, manufactured by Denka Co., Ltd.)

### <Formation of Surface Layer>

In the same manner as in the production of the multilayer endless belt 1, surface layers having a thickness of 2 μm were formed, and the multilayer endless belts 2 to 8 were prepared. The structures of the base material layer and elastic layer of the multilayer endless belts produced are indicated below.

TABLE I

| | | | | | | | | | | | | | | | Sum of | |
|---|---|---|---|---|---|---|---|---|---|---|---|---|---|---|---|---|
| | Base material layer | | | | | | Elastic layer | | | | Ratio of | | | | average | |
| | | Average | | | Ratio of | | | Average | | | thickness | | Ratio of | | thickness | |
| | | thickness | | | thickness | | | thickness | | | of elastic | | width | | of base | |
| | | Central | | | of both end | | | Central | End | | layer to | | of both end | | material | |
| Multi- | | region | Both end | | regions to | | | region | regions | | base material | | regions to | | layer and | |
| layer | | A | regions B | | central region | | | A | B | | layer in both | | the total | | elastic | |
| endless | | a1 | b11 | b12 | b11/a1 | b12/a1 | Rubber | a2 | b21 | b22 | end regions | | width (%) | | layer | |
| belt No. | Resin | (μm) | (μm) | (μm) | (%) | (%) | material | (μm) | (μm) | (μm) | b21/b11 | b22/b12 | B1 | B2 | (μm) | Remarks |
| 1 | PI | 100 | 150 | 150 | 150 | 150 | NBR | 300 | 250 | 250 | 1.67 | 1.67 | 10 | 10 | 400 | Present |
| | | | | | | | | | | | | | | | | invention |
| 2 | PI | 120 | 144 | 144 | 120 | 120 | SR | 400 | 376 | 376 | 2.61 | 2.61 | 8 | 8 | 520 | Present |
| | | | | | | | | | | | | | | | | invention |
| 3 | PI | 130 | 156 | 156 | 120 | 120 | SR | 500 | 474 | 474 | 3.04 | 3.04 | 17 | 17 | 630 | Present |
| | | | | | | | | | | | | | | | | invention |
| 4 | PAI | 100 | 150 | 150 | 150 | 150 | CR | 350 | 300 | 300 | 2.00 | 2.00 | 15 | 15 | 450 | Present |
| | | | | | | | | | | | | | | | | invention |
| 5 | PAI | 110 | 143 | 143 | 130 | 130 | NBR | 250 | 217 | 217 | 1.52 | 1.52 | 12 | 12 | 360 | Present |
| | | | | | | | | | | | | | | | | invention |
| 6 | PI | 100 | 100 | 100 | 100 | 100 | NBR | 300 | 300 | 300 | 3.00 | 3.00 | 10 | 10 | 400 | Compar- |
| | | | | | | | | | | | | | | | | ative |
| | | | | | | | | | | | | | | | | example |
| 7 | PI | 120 | 192 | 192 | 160 | 160 | SR | 400 | 328 | 328 | 1.71 | 1.71 | 12 | 12 | 520 | Compar- |
| | | | | | | | | | | | | | | | | ative |
| | | | | | | | | | | | | | | | | example |
| 8 | PI | 130 | 143 | 143 | 110 | 110 | SR | 500 | 487 | 487 | 3.41 | 3.41 | 15 | 15 | 630 | Compar- |
| | | | | | | | | | | | | | | | | ative |
| | | | | | | | | | | | | | | | | example |

### <Evaluation>

The above-produced multilayer endless belt was incorporated into an inkjet image forming apparatus and an electrophotographic image forming apparatus as an intermediate transfer belt, and the durability of each was evaluated. Moreover, the amount of warpage of the end portion in the width direction was evaluated. The multilayer endless belts 1 to 3 and 6 to 8 were mounted on an inkjet image forming apparatus, and the multilayer endless belts 4 to 5 were mounted on an electrophotographic image forming apparatus for evaluation.

### [Warpage]

For each of the multi-layer endless belts, it was cut in the width direction and placed on a flat table, and separating 20 cm from the cut portion, the maximum value of the amount floating from the flat table was measured with a caliper, and this was taken as the amount of warpage.

### [Evaluation by Inkjet Image Forming Apparatus]

### <Preparation of Ink 1>

### (Preparation of Pigment Dispersion)

The following components were blended so that the total amount was 100 mass parts. This was put together with 120 g of 0.5 mmp zirconia beads in a 200 ml polyethylene container with a lid, then the lid was closed and dispersed with a paint conditioner for 3 hours. Thereafter, the beads were separated to obtain a pigment dispersion.

| | | |
|---|---|---|
| C.I. Pigment Blue 15:3 (manufactured by DIC, | 20.0 | mass parts |
| TGR/no surface treatment): | | |
| Tripropylene glycol diacrylate | 71.9 | mass parts |
| (photopolymerizable compound): | | |
| Solsperse 3000 (manufactured by Lubrizol | 8.0 | mass parts |
| Co. Ltd., polymer dispersant): | | |
| Irgastab UV-10 (manufactured by BASF, | 0.1 | mass parts |
| polymerization inhibitor): | | |

### (Preparation of Ink)

An ink 1 was prepared by adding the following components so as to have the following proportions while heating the obtained pigment dispersion to 60° C.

| | | |
|---|---|---|
| Pigment dispersion liquid: | 20.0 | mass % |
| PO modified neopentyl glycol diacrylate | 34.8 | mass % |
| (photopolymerizable compound): | | |
| Polyethylene glycol #400 diacrylate | 20.0 | mass % |
| (photopolymerizable compound): | | |
| 4EO modified pentaerythritol tetraacrylate | 20.0 | mass % |
| (photopolymerizable compound): | | |
| Irgacure 819 (manufactured by BASF, | 3.0 | mass % |
| photopolymerization initiator): | | |
| Irgastab UV-10 (manufactured by BASF, | 0.1 | mass % |
| photopolymerization inhibitor): | | |
| KF-352 (Shin-Etsu Silicone, surfactant): | 0.1 | mass % |
| Kao wax T-1 (gelling agent, manufactured | 2.0 | mass % |
| by Kao Corporation): | | |

The intermediate transfer belt 201 produced as the intermediate transfer belt (201) was attached to the image forming apparatus shown in FIG. 4, and the prepared ultraviolet curable ink was filled in the inkjet head (211K).

Next, a repetitive halftone image composed of 1 dot line-1 dot not printed-1 dot line was printed on the intermediate transfer belt 1 from an inkjet head at a printing speed of 600 mm/s (resolution: 1200×1200 dpi, ink droplet size: 10 pL). Next, preliminary curing was performed in the first light irradiation unit (240) using an ultraviolet LED light source having a wavelength of 395 nm and an irradiation intensity of 200 mW/cm².

Next, the pressing force of the support roller (23) against the paper transport unit (30) was 20 kN/m, and the formed image was transferred to embossed paper (Rezac 66, 260 kg paper) as a recording medium. Finally, in the second light irradiation part (250), a main curing was performed using an ultraviolet LED light source having a wavelength of 395 nm and an irradiation intensity of 500 mW/cm², thereby producing a printed matter 1. Further, 10,000 halftone images were output.

[Evaluation by electrophotographic image forming apparatus] The produced intermediate transfer belt was mounted as an intermediate transfer belt of an image forming apparatus “bizhub PRESS C11000” (manufactured by Konica Minolta), and 10,000 halftone images with a printing rate of 30% were output using embossed paper (Rezac 66 260 kg paper).

### (Evaluation of Halftone Image)

10000 halftone images were output, and the first, 500th and 1000th visible images were visually checked, and the black halftone images were evaluated according to the following evaluation criteria.

AA: Transfer unevenness is not recognized.

BB: Slight transfer unevenness is observed.

CC: Uneven transfer is observed but there is no practical problem.

DD: Distinct uneven transfer is observed and there is a problem in practical use.

The evaluation results are indicated in Table II. In the case where the evaluation could not be continued due to poor running during the evaluation, it was marked as running failure in the table. In these, the end portion of the intermediate transfer belt was in contact with the apparatus main body and was damaged

TABLE II

| Multilayer | Amount of | Image evaluation | | | | |
|---|---|---|---|---|---|---|
| endless | warpage | | First | 5000th | 10000th | |
| belt No. | (mm) | Image | image | image | image | Remarks |
| 1 | 1.1 | Inkjet image | AA | AA | AA | Present invention |
| 2 | 1.6 | Inkjet image | AA | AA | BB | Present invention |
| 3 | 1.9 | Inkjet image | BB | BB | BB | Present invention |
| 4 | 1.4 | Electrophotographic | AA | AA | AA | Present invention |
| | | image | | | | |
| 5 | 1.5 | Electrophotographic | AA | AA | BB | Present invention |
| | | image | | | | |
| 6 | 3.4 | Inkjet image | BB | BB | Running | Comparative example |
| | | | | | failure | |
| 7 | 3.1 | Inkjet image | AA | CC | Running | Comparative example |
| | | | | | failure | |
| 8 | 5.4 | Inkjet image | BB | Running | DD | Comparative example |
| | | | | failure | | |

From Table II, it can be seen that the intermediate transfer belt using the multilayer endless belt of the present invention has less warpage and excellent durability. Although the embodiments of the present invention have been described and illustrated in detail, the disclosed embodiments are made for purpose of illustration and example only and not limitation. The scope of the present invention should be interpreted by terms of the appended claims

What is claimed is:

1. A multilayer endless belt comprising a base material layer having thereon an elastic layer in that order from an inner side of the multilayer endless belt,
wherein in a width direction of the multilayer endless belt, an average thickness of both end regions of the base material layer is in the range of 120 to 150% with respect to an average thickness of a central region of the base material layer, and an average thickness of both end regions of the elastic layer is thinner than an average thickness of a central region of the elastic layer.

2. The multilayer endless belt described in claim 1,
wherein an outer peripheral length of the multilayer endless belt is 800 mm or more, the average thickness of the central region of the base material layer is in the range of 100 to 130 μm, and an average thickness of the central region of the multilayer endless belt is 300 μm or more.

3. The multilayer endless belt described in claim 1,
wherein a length in the width direction of the both end regions is in the range of 8 to 17% from both ends with respect to the width of the multilayer endless belt.

4. The multilayer endless belt described in claim 1,
wherein the average thicknesses of the base material layer and the elastic layer in the both end regions satisfy the following relation 1,
(Average thickness of elastic layer in both end regions)/(average thickness of base material layer in both end regions)≤3.5. Relation 1:

5. The multilayer endless belt described in claim 1,
wherein the total average thickness of the base material layer and the elastic layer is the same in the both end regions and the central region.

6. The multilayer endless belt described in claim 1, used as an intermediate transfer belt for inkjet image formation.

7. The multilayer endless belt described in claim 1, used as an intermediate transfer belt for an intermediate transfer belt for forming an electrophotographic image.

8. An inkjet image forming apparatus including the multilayer endless belt described in claim 6.

9. An electrophotographic image forming apparatus including the multilayer endless belt described in claim 7.

10. A method of forming the multilayer endless belt described in claim 1 comprising the step of:
forming the base material layer by applying a coating liquid containing a polyimide resin precursor or a polyamideimide resin precursor using a nozzle that moves relative to an outer peripheral surface to form a coating film in the central region, then to form a coating film in the both end regions.

11. A method of forming the multilayer endless belt described in claim 1, comprising the step of:
forming the elastic layer by applying a coating liquid containing an acrylonitrile rubber, a chloroprene rubber or a silicone rubber using a nozzle that moves relative to a surface of the base material layer to form a coating film in the central region, then to form a coating film in the both end regions.
